(19) United States
(12) Patent Application Publication
(10) Pub. No.: US 2003/0150921 A1
(43) Pub. Date: Aug. 14, 2003

(54) Device for sensing magnetically marked paper and marked paper readable by said device

(76) Inventors: Olivier Acher, Monts (FR); Marc Ledieu, Ballan Mire (FR); Jean-Claude Joubert, Venon (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/296,219

(22) PCT Filed: Jun. 19, 2001
(86) PCT No.: PCT/FR01/01907

(30) Foreign Application Priority Data
Jun. 20, 2000 (FR) 00/07842

(51) Int. Cl. G06K 19/06

(52) U.S. Cl. 235/493; 340/572.6

(57) ABSTRACT

The invention relates to a marked paper document and a marked paper document detection device. The device comprises excitation means (A1, A2, A3) for varying the magnetization of glass-covered amorphous ferromagnetic filaments contained in the marked paper document with time, and means for detecting a variation in the magnetization of the ferromagnetic filaments.

The invention is applicable to checking reproduction of documents and authentication of documents.

### TECHNICAL FIELD AND PRIOR ART

The present invention relates to a marked paper document and a detection device capable of detecting a marked paper document according to the invention.

Protection of sensitive information is a very important concern in companies and in public or private organizations. The risk of information being divulged may be the result of organized deliberately fraudulent acts. In this case, the range of available means (cameras, means of bypassing surveillance devices, etc.) cannot prevent deliberately fraudulent acts unless the personnel in contact with the sensitive information are authorized.

Another risk of information being divulged is due to the negligence of personnel who can use reproduction means available in his or her environment (photocopiers, scanners, fax, etc.) to reproduce confidential documents not listed in the registers kept by the company and over which there is actually no control.

In general, rules for storage, communication and reproduction are set down for original confidential documents. Documents originating from total or partial pirate reproduction of a confidential original document may be treated negligently.

According to known art, reproduction of confidential documents is prohibited through the use of paper commonly called “anti-photocopy paper”. Anti-photocopy paper contains diffraction patterns (see U.S. Pat. No. 5,830,609) or luminescent pigments (see U.S. Pat. No. 5,271,645). The characteristic of anti-photocopy paper is that it makes it impossible to photocopy documents using standard type photocopiers or scanners. It has the disadvantage that it prevents reproduction even in a control context.

Other means of marking paper are known, for authentication purposes. These means include marking with magnetic pigments (see U.S. Pat. No. 5,631,039). Magnetic pigments are of the same type as those used for magnetic recording. These pigments can only be detected with a magnetic sensor placed very nearby (typically, the distances between the sensor and the pigments are less than 1 mm). The main purpose is to make it impossible to add characteristics to an imitated document so that it can be used as an authentic document.

Thin magnetic tapes or ferromagnetic wires with a Barkhausen effect are also used for marking purposes (see U.S. Pat. No. 520,456). The use of thin magnetic tapes and ferromagnetic wires was widely used in theft resistance surveillance systems commonly called EAS (Electronic Article Surveillance) systems. EAS systems are mainly intended to prevent theft of merchandise in shops, or books in libraries (see U.S. Pat. No. 4,075,618 and U.S. Pat. No. 3,665,449).

Magnetic marker detection systems for anti-theft surveillance have a number of implicit or explicit characteristics (for example, see international patent application WO-99/30384 and U.S. Pat. No. 5,793,289) indicated below:

the query/detection system consisting of antennas is fixed, and the objective is to detect a moving object,

the query is made using coil type antennas, possibly including a mild material that acts as a pole or yoke, but is not made with a permanent magnet system,

the query area corresponds to a relatively large volume,

the antennas can be located on each side of the query area,

the magnetic orientation of the marker can be arbitrary,

the selectivity must be large, to avoid metallic or magnetic masses corresponding to purchases made by customers of shops protected by EAS, from generating a theft detection,

mass and electricity consumption constraints of antennas are low.

The invention does not have the disadvantages mentioned above.

### PRESENTATION OF THE INVENTION

The invention relates to a marked paper document comprising a polymer layer containing glass-covered amorphous ferromagnetic filaments.

The invention also relates to a process for making a marked paper document comprising a step in which the glass-covered amorphous ferromagnetic filaments are incorporated into a polymer layer.

The invention also relates to a marked paper document detection device according to the invention. The detection device comprises excitation means for varying the magnetization of the ferromagnetic filaments contained in the marked paper document with time, and means for detecting a variation in the magnetization of the ferromagnetic filaments.

The invention also relates to a document authentication device comprising a detection device like the detection device according to the invention.

The invention also relates to a paper document reproduction control system. The control system comprises a detection device like the detection device according to the invention.

The invention also relates to a paper document reproduction apparatus comprising a control system like the control system according to the invention.

The invention also relates to a paper document reproduction process comprising the following steps:

insertion of the paper document in the reproduction device according to the invention,

detection of the presence or absence of ferromagnetic filaments in the paper document,

prohibition to reproduce the paper document in the presence of a detection of ferromagnetic filaments.

The marked paper document according to the invention is preferably in the form of a sheet of paper.

Advantageously, the marked paper document detection device according to the invention allows documents to be reproduced using standard photocopy means. The user is allowed to make photocopies (subject to conditions) of the documents using standard photocopy means and this very advantageously distinguishes the invention from prior art mentioned above. It is frequently useful, for service reasons, to photocopy all or some of a document only to take extracts from it, or to make transparencies for overhead projections, etc. Advantageously, according to the invention, the means that authorize reproduction of the marked paper document may be managed accordingly. The number of reproductions of the document can thus be strictly controlled. It is then possible to keep a trace of the number of photocopies made. More generally, an efficient policy may be set up for filing and reproduction of classified documents.

Reproduction of the classified document by means other than those authorized by the device according to the invention (for example reproduction by photography) requires that a premeditated action should be carried out that cannot be qualified as being negligence. It is also possible to remove the classified document(s) from the company, to reproduce it (them) using conventional means, but here again a serious degree of fault is necessary which cannot be qualified as being negligence.

A document reproduction system according to the invention enables the company organization to set up reproduction and traceability procedures for classified documents, that are efficient in that classified documents cannot be reproduced other than by using the procedures.

The device according to the invention is significantly different from EAS type anti-theft systems mentioned above. The system according to the invention is different from the EAS type anti-theft system in all respects listed above. For example according to the invention, it is necessary to detect much lower quantities of magnetic material than the quantities that are typically detected to make an EAS type marker.

The invention can also be used to authenticate the fact that some documents such as official documents are originals, and to distinguish them from falsified documents or documents reproduced by photocopies, even with sophisticated means. The paper marking process according to the invention has the advantage that it distributes the marker over the entire surface of the document and it is practically invisible. Furthermore, the marking advantageously remains present throughout the life of the document, for example even if the document is crumpled. The protected document according to the invention may also be used to make various shapes of labels that can be fixed on objects for authentication purposes, by cutting out.

According to the invention, it is also possible to detect paper areas smaller than, or very much smaller than, the standard size of an A4 format sheet of paper (A4 format=210×300 mm²), such that cutting out a portion of a classified document will not make it possible to reproduce it.

Soft magnetic inclusions of the marked paper are detected using the non-linear characteristic of the applied field—magnetization response (magnetic hysteresis cycle). This non-linearity may be used through the generation of harmonics of the response to a sinusoidal excitation; or due to detection of Barkhausen's skips characterizing the sudden change in magnetization.

Magnetic excitation must essentially allow a pass through at least ½ magnetic hysteresis cycle. Therefore, a field must be generated passing from a saturated state to the opposite state.

It is clear that considering the relatively small volume of mild material included in the paper, the detection system must be very sensitive. A differential device may be an advantageous means for eliminating external electromagnetic noise.

Data may also be processed by means of a circuit using analogue electronics. Filters are then used to extract the useful signal from signals picked by the detection system. Digital electronics may also be used for signal processing. Spectral processing (Fourier transform) can be used to extract interesting harmonics.

The device to inhibit the reproduction capability of the equipment according to the invention may be composed of a mechanical switch (relay type) or an electronic switch (transistor) in its simplest form, which switches the equipment light power supply off. A more sophisticated solution will be to generate signals that can interact with an equipment control card.

### BRIEF DESCRIPTION OF THE FIGURES

Other characteristics and advantages of the invention will become clear upon reading a preferred embodiment of the invention described with reference to the appended figures, wherein:

FIG. 1 shows a first example configuration with permanent magnets for obtaining magnetic excitation according to a first embodiment of the invention;

FIG. 2 shows the magnetic excitation obtained using a configuration according to FIG. 1;

FIG. 3 shows a second example configuration with permanent magnets for obtaining a magnetic excitation according to the first embodiment of the invention;

FIG. 4 shows the magnetic excitation obtained using a configuration according to FIG. 3;

FIG. 5 shows a detection device configuration according to a second embodiment of the invention;

FIG. 6 shows an improvement to the configuration shown in FIG. 5;

FIG. 7 shows an application of the detection device according to the invention, to a document reproduction apparatus;

FIG. 8 shows a first example of a marked paper document according to the invention;

FIG. 9 shows a second example of a marked paper document according to the invention;

FIG. 10 shows a principle diagram for the process for reproduction of a paper document according to the invention.

The same references denote the same elements in all figures.

### PRESENTATION OF PREFERRED EMBODIMENTS OF THE INVENTION

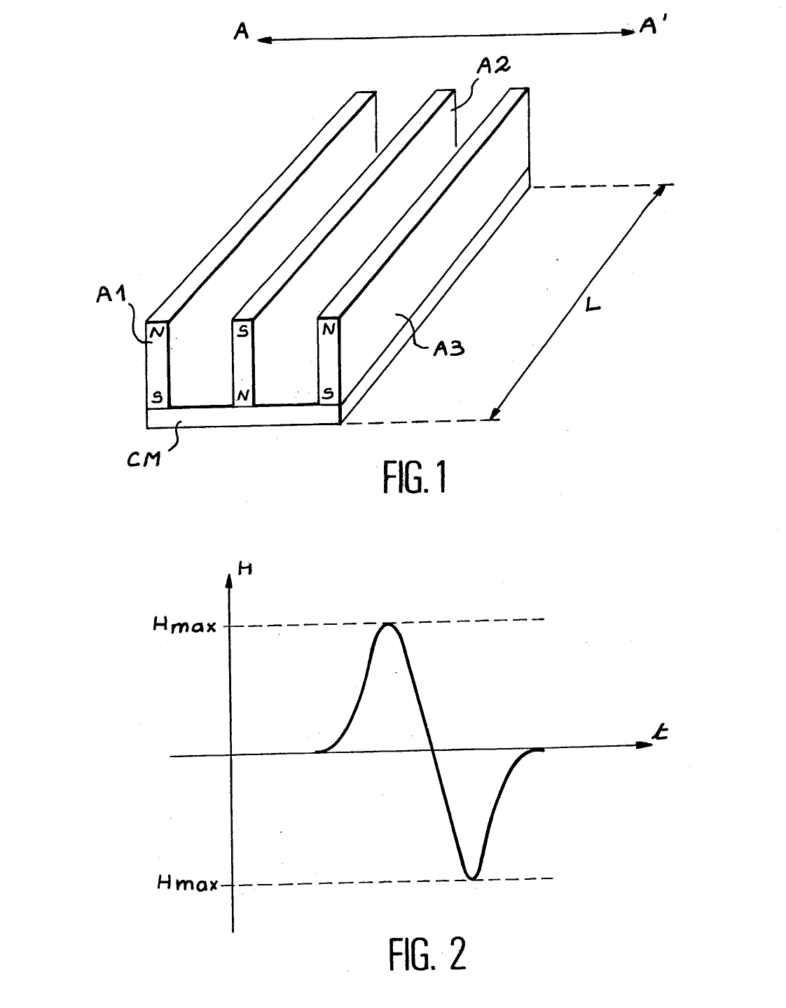

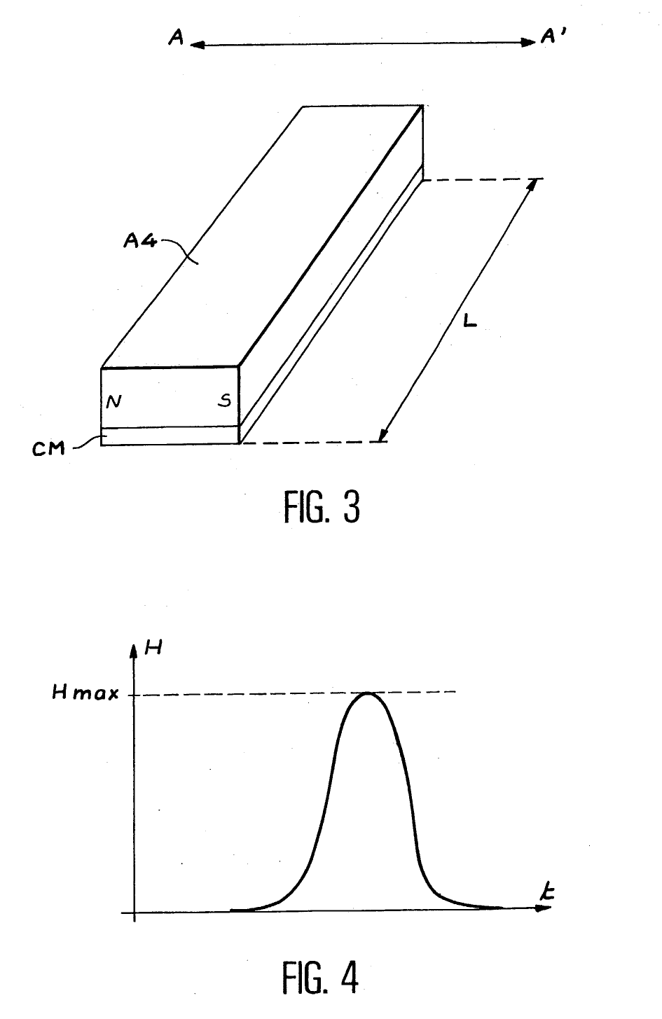

FIGS. 1 and 3 show two examples of excitation configurations of the mild magnetic material placed in the marked paper, according to a first embodiment of the invention. FIG. 2 shows the variation with time of the magnetic excitation at a point on the marked paper corresponding to the configuration in FIG. 1, and FIG. 4 shows the variation with time of the magnetic excitation at a point on the marked paper corresponding to the configuration in FIG. 3.

The configuration shown in FIG. 1 comprises a set of three permanent magnets in the form of three magnetized bars A1, A2 and A3 with a rectangular section mounted in opposition. The axis defined by the north and south poles of each bar is approximately perpendicular to the plane of the sheet of marked paper (not shown in the figure). In FIG. 1, the section of the magnetized bars is approximately rectangular, however the invention also relates to the case in which the section of the bars is approximately square. The three magnetic bars A1, A2 and A3 are mounted on a magnetic yoke CM that enables the field lines to close so as to limit their extension within useful areas. The width L of the bars along the direction perpendicular to the axis defined by the poles is equal to approximately the width of a marked sheet of paper.

The configuration in FIG. 3 comprises a permanent magnet in the form of a magnetized bar A4 with an approximately rectangular section. The axis defined by the north and south poles of the bar A4 is approximately parallel to the plane of the sheet of marked paper. The bar A4 is installed on a magnetic yoke CM. The width L of the bars is also approximately equal to the width of a sheet of marked paper.

According to the example shown in FIG. 3, a single bar A4 participates in the magnetic excitation. According to a variant of the embodiment of FIG. 3, the invention also relates to the case in which several bars participate in the magnetic excitation. The bars are then placed parallel to each other on the yoke CM. The north poles of the different bars are then all positioned on the same first side and the south poles are all on the same second side opposite to the first side.

More generally, permanent magnets may be arranged in different ways. It should be attempted to create a variable magnetic excitation in time, for a scanned area of a document, so that magnetisation of the mild magnetic inclusions in the marked paper can be changed over. This is done by moving the magnetised bars along a direction parallel to the plane of the document (direction AA′ in FIGS. 1 and 3).

The maximum value Hmax of the magnetic field H produced during displacement of the magnetic bars (see FIGS. 2 and 4) must be significantly greater than the values of the anisotropy field of the magnetic materials involved and also sufficiently weak to that it does not disturb normal operation of the original reproduction device (photocopier magnetic toner, spectrum of the neon type lamp in the scanners, etc.). As mentioned above, the magnetic yoke CM closes the field lines for this purpose, and prevents their extension into non useful zones.

The configuration shown in FIG. 1 creates an alternately positive and negative excitation (see FIG. 2). The configuration shown in FIG. 3 creates a magnetic field gradient; in this case, the principle is based on the observation that magnetic inclusions present in the paper are dispersed isotropically, and that their magnetization state is arbitrary at any given moment. Positioning of magnets with different orientations perpendicular to the scanning direction prevents easy pirating of the device.

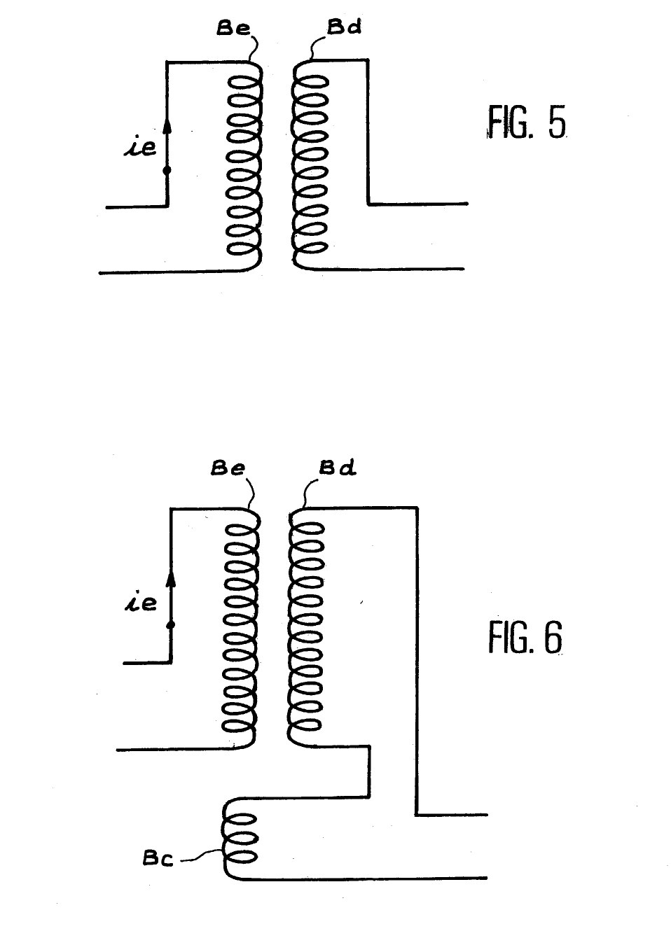

FIG. 5 shows a configuration with an excitation coil according to a second embodiment of the invention. FIG. 6 shows an improvement to the configuration shown in FIG. 5.

An exciting coil, Be, through which an alternating excitation current ie allows to generate a magnetic field with a sinusoidal amplitude. The frequency of the excitation current ie allows to excite the magnetic inclusions. As a non-restrictive example, the frequency of the excitation current may be equal to 1 kHz. Excessively low excitation frequencies (for example about 50 Hz) are preferably not used to prevent pollution by mains power supplies and their harmonics.

The amplitude of the excitation current is adjusted to saturate the material at each period, preferably with a safety margin corresponding to a disturbing external static magnetic field.

Variations in the magnetization of magnetic elements contained in the marked paper are detected by one or several detection coils Bd. The use of detection coils Bd also relates to the case in which magnetic excitation is done using excitation coils (see FIGS. 5 and 6) and also the case in which magnetic excitation is done using permanent magnets (see FIGS. 1 and 3).

If the excitation is achieved by permanent magnets, the most attractive solution is to place the coils in the immediate vicinity of the permanent magnets, since the coil(s) is (are) then more compact. If several coils were used, it would for example be interesting to connect them in series to simplify the information processing circuit. The number of turns on the reception coils must be high to give a high sensitivity.

According to the preferred embodiment of the invention, the permanent magnets are moved with respect to the marked paper document that remains fixed. The invention relates equally to the case in which the detection coils move at the same time as the permanent magnets, and to the case in which the detection coils are fixed. If the coils are fixed, it would for example be possible to use one or several fixed coils that surround the entire reproduction surface of the reproduction device in a single turn. It would then be possible to wind the detection coil(s) around the window of the reproduction means.

In all cases, according to one improvement of the invention, it is advantageous to use a differential system that increases the sensitivity of the device (signal to noise ratio). Apart from the detection coil Bd, a compensation coil Bc eliminates the component of the signal related to the variation of the magnetic field generated by the excitation means (see FIG. 6).

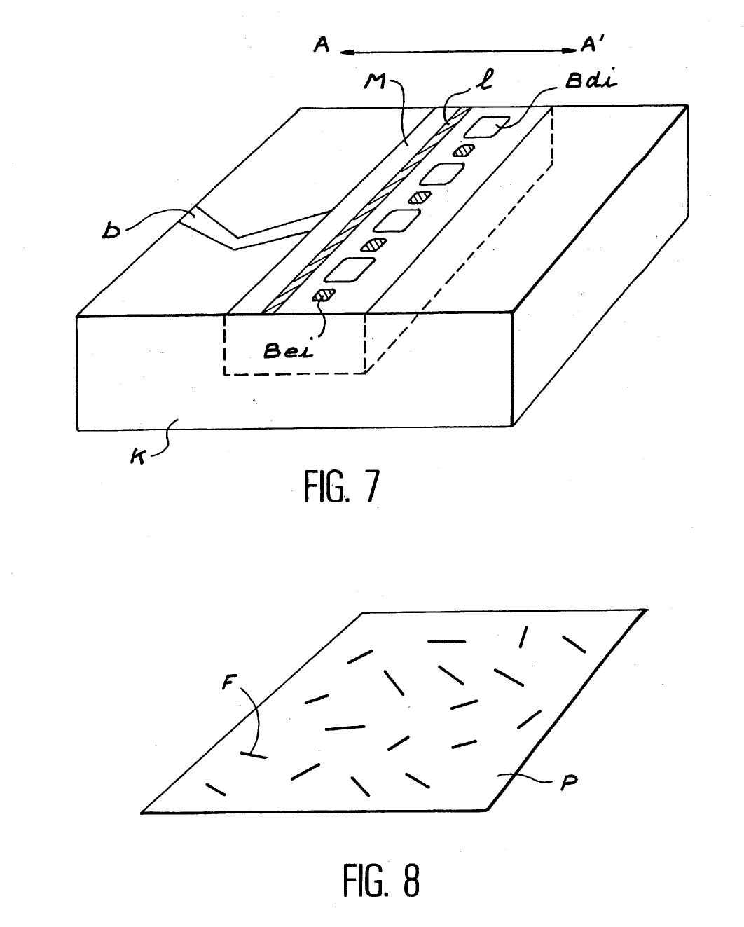

FIG. 7 shows an application of the detection device according to the invention to document reproduction apparatus. For example, the document reproduction apparatus may be a photocopier, a scanner, a fax, etc. FIG. 7 shows a box K, a structure M supporting the light source 1 that illuminates the document and an arm b to move the support structure M in the box K. According to the embodiment shown in FIG. 7, the support structure M also comprises excitation coils Bei and detection coils Bdi. In this case the detection head part of the detection device is fixed to the structure M that holds the light source, which advantageously enables scanning of the entire reproduction area and putting the detection head very close to the original document.

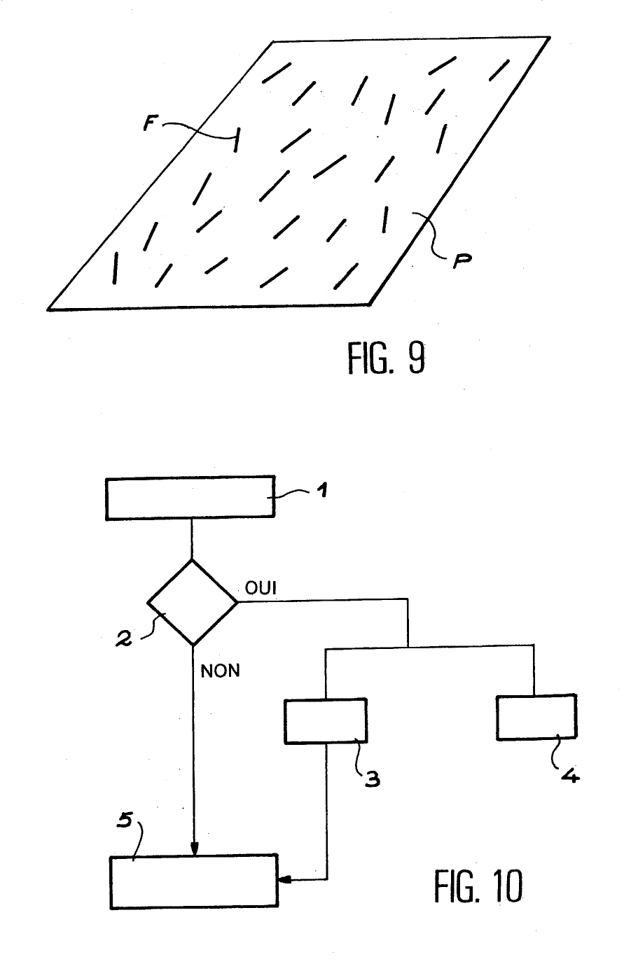

FIGS. 8 and 9 show two examples of paper documents protected according to the invention. FIG. 8 shows the case in which the ferromagnetic filaments are distributed isotropically on the sheet of paper and FIG. 9 shows the case in which the filaments are all aligned in approximately the same direction.

Preferably, the ferromagnetic filaments have a saturation field with a value less than or equal to 300 A/m.

The paper document protected according to the invention consists of a sheet of paper P in which glass-covered amorphous ferromagnetic filaments F are incorporated on the surface. The ferromagnetic filaments F are incorporated into the surface layer of the paper at the time of the coating operation. The filaments are then dispersed in the colloidal aqueous suspension spread on the surface of the fibrous cellulose support (coated paper).

The glass-covered ferromagnetic filaments may be produced by drawing a molten metal core contained in a borosilicate glass tube as described in the document reference “Ferromagnetic resonance in amorphous magnetic wires” by S. A. Baranov et al. (Phys. Met. Metall., No. 1, vol. 67, p. 70 to 75, 1989). They may have any one of the following compositions: CoFeSiB, or CosiB, or FeSiB, with a proportion of Si+B significantly greater than 18% and significantly less than 35% in order to obtain an amorphous material, and a content of Co and Fe of more than 40%. Elements such as Ni (for example from 0 to 20%), Mo, Zr, Ge, Cr, Mn, V, Ti, C or other metals or metalloids with contents for example of less than 7%, can also be added to these main constituents.

The ferromagnetic filaments may have positive magnetostriction, in which case they will have a large Barkhausen's skip, or they may have a negative magnetostriction, in which case they will not have a Barkhausen's skip. We will consider filaments that reach saturation for an applied external field along their axis less than a few hundred A/m. The properties of these materials that depend on their composition are well known, as described in the document reference “Magnetic hysteresis in glass-covered and water-quenched amorphous wires” by H. Chiriac, T. A. Ovari, M. Vasquez and A. Hernando (Journal of Magnetism and Magnetic Materials 177-171, 1998, p. 205 and 206).

The magnetization of filaments with a Barkausen's skip under the effect of a very small amplitude external excitation magnetic field (typically of the order of a few hundred A/m) and with a frequency of more than a few hundred hertz, suddenly reverses twice per period producing a flux variation that can easily be detected by an antenna (detection coil) located close to the means that create the excitation field. In all cases, the applied field must be greater than the filament saturation field. The detection coil is capable of detecting a flux pulse. This is due to the bistable nature of the magnetization resulting from the magnetic characteristics of the alloy and magnetostriction actions produced by the sheath. The sudden reversal of magnetization while the external alternating field rises during a semi-period causes a signal to appear (variation of the flux induced in the detection coil) comprising a large number of frequency harmonics multiple of the excitation frequency (a few tens of kilohertz). The harmonics are easy to identify and, if applicable, make it possible to discriminate with the lowest frequency parasite signals generated by the more conventional and less mild magnetic materials, if these materials are present close to the document to be controlled and would disturb its magnetic environment.

Filaments with negative magnetostriction without a Barkhausen's skip but with a saturation field of less than a few hundred A/m, also create harmonics under the same conditions. This is due to the fact that their magnetisation varies non linearly with time.

The optimum preferred length of the filaments is approximately 10 mm. It may also be of the order of 7 mm, without the modification to the shape anisotropy or the magnetostriction effects significantly modifying the magnetization change-over conditions, and consequently, the amplitude of the signal that remains essentially proportional to the quantity of material incorporated in the paper.

The maximum total diameter of the composite bi-material filaments is usually less than 20 μm, so that the thickness of the latex polymer coating layer can be fixed between 30 and 40 μm after drying, leading to a total paper thickness (cellulose support+coating layer) of at least 80 μm. However, there is no imposed upper limit on the thickness of the security paper sheet. The small total diameter of filaments enables them to be incorporated into the colloidal aqueous solution of latex polymer spread on the cellulose support of the paper during the coating operation.

In order to be easily detectable, the concentration of ferromagnetic material in the protected paper must be significantly greater than 1 mg/M². Incorporation and dispersion of filaments in the coating suspension, which also contains white pigments and other additives in addition to latex colloids, is done by intensive mixing, for example using a blade mixer. The filaments have a high mechanical strength and are particularly flexible, and advantageously are not damaged by the mixing operation. Furthermore, due to its glass composition, the sheath enables good wetting of the surface of the filaments by the aqueous colloidal suspension, and the suspension thus obtained is very homogeneous, with no lumps and with a fairly low viscosity, and with characteristics that can remain stable during storage (for example, storage for a few hours at ambient temperature).

Coating is done by a Blade method, followed by pre-drying and possibly glazing. Due to the presence of the glass cover, the metallic fibres are not significantly corroded in the liquid in suspension. Note that when the fibre concentration does not exceed 80 mg/M² and the dispersion in the coating spray has been made satisfactorily, the filaments are significantly elongated within the thickness of the layer. The presence of fibres in the add-on layer is then difficult to detect with the naked eye, to the extent that the security paper advantageously looks very similar to non-security paper, and this appearance may also be reinforced by the addition of a filament free layer, for example 2 to 3 μm thick, covering the layer that contains the filaments.

In the case of relatively long filaments, for example between 1 and 2 cm, the mechanical conditions for coating the paper at high advance speeds causes a certain degree of alignment of the filaments under the effect of the viscosity forces within the suspension (see FIG. 9). Detection of this type of paper then depends on the orientation with which the sheets are inserted with respect to the detector, and in a favourable case the signal is significantly reinforced. Furthermore, it is found that the filaments can be crossed without changing the overall properties. Note that the orientation phenomenon does not occur for short fibres (for example fibres between 5 and 8 mm long), in this case the orientation is statistical (see FIG. 8).

It is important to note that when marking takes place over the entire surface of the paper, a smaller cut-out part of the paper surface is advantageously always detectable, thus providing greater security and a large discretisation of the marker material.

Furthermore, for fibres with a diameter not exceeding 20 μm, the magnetic field always penetrates as far as the heart of the filaments, even when the excitation frequency is higher than a few tens of kilohertz (the skin effect at these frequencies only starts to be noticeable for filament diameters of 30 μm or more). The entire magnetic alloy is then advantageously useful to contribute to the detected signal.

The characteristics of security paper advantageously make it compatible with all conventional uses for printing and office automation, like conventional paper. In particular, security paper according to the invention may be placed in the send tray of a photocopy machine of any format. The presence of glass covered metallic filaments does not prevent characters from being printed on the paper. Thus, it is easy to produce documents that must be considered as being sensitive and that cannot be divulged.

One example embodiment of security paper will now be described below. In this example, it is considered that the glass-covered mild ferromagnetic filaments have a total diameter of 15 μm, and the thickness of the glass cover is equal to 2 μm. The filaments are made by a known method derived from Taylor's process, that consists of heating a given quantity of metal introduced into a closed borosilicated glass tube, by induction. A filament is initiated and wound around a winding machine. The glass used is a Pyrex type borosilicate glass, with a melting temperature of about 600° C. The metal alloy is of the CoMnSiB type and contains an atomic proportion of Cobalt of between 75 and 80%. Filaments have negative magnetostriction and an anisotropy field of 1 Oe, equal to 80 A/m. Filaments are cut to a length of 7 mm and are dispersed in the coating suspension. The concentration of filaments is more than 5 g/m². This preparation may be put on one of the faces or on both faces of the sheet of paper. At this concentration, the filaments are advantageously invisible when the thickness of the coating is between 30 and 40 μm. The presence of the filaments does not hinder writing or printing on the paper.

FIG. 10 shows a principle diagram for the reproduction process of the paper document according to the invention.

The process comprises a step 1 in which the original document is inserted in the reproduction device followed by a step 2 to detect the presence of marked paper. When the original document is presented to the reproduction device, a detection device according to the invention detects whether or not any marked paper is present. If marked paper is detected, the reproduction function is disabled (step 4). An alarm generation or any other display or counting means may also be integrated into the detection device to signal the presence of marked paper. According to one improvement to the invention, the disable function may be cancelled by a special device leading to authorization to reproduce the document (step 3).

Advantageously, the reproduction device according to the invention comprises a detection step that is added to an existing reproduction device. The electrical power supply to the added device may be made independently, or using a resource specific to the reproduction means. For portable reproduction means, there is no problem in using a battery power supply for the device.

Despite the presence of marked paper, reproduction may be authorized by any means that satisfies the organizational requirements of the industry or organization that uses the means according to the invention. This authorization may be sent to the control device in a coded or uncoded manner. It is obvious that for cases in which this authorization is not used, the added device does not need any input enabling access to any authorization function (limitation of risks of pirating or deliberate bypassing of the authorization function).

The detection device used to detect the potential presence of marked paper detects over the entire reproduction area, even if the area of the paper to be analysed is reduced (for example by cutting out a confidential document in an attempt to reproduce the document despite the marking).

1. Marked paper document characterised in that it comprises a polymer layer containing glass-covered amorphous ferromagnetic filaments (F) incorporated and dispersed by mixing in the polymer layer.

2. Marked paper document according to claim 1, characterised in that the ferromagnetic filaments have a saturation field with a value less than or approximately equal to 300 A/m.

3. Marked paper document according to claim 1 or 2, characterised in that the ferromagnetic filaments (F) have positive magnetostriction.

4. Marked paper document according to claim 1 or 2, characterised in that the ferromagnetic filaments (F) have negative magnetostriction.

5. Marked paper document according to any one of claims 2 to 4, characterised in that the diameter of the ferromagnetic filaments (F) is less than or approximately equal to 20 μm and the length is between 3 mm and 3 cm.

6. Marked paper document according to any one of claims 1 to 5, characterised in that the concentration of filaments is within a range between approximately 4 mg/m² and 80 mg/m².

7. Process for making a paper document, characterised in that it comprises a step during which glass-covered amorphous ferromagnetic filaments (f) are incorporated and dispersed by mixing into a polymer layer.

8. Process according to claim 7, characterised in that the glass-covered amorphous ferromagnetic filaments (F) are dispersed in a colloidal aqueous suspension spread on the surface of a fibrous cellulose support.

9. Marked paper document (P) detection device, characterised in that the marked paper document is a document according to any one of claims 1 to 6, and it comprises excitation means (A1, A2, A3; A4; Be) for varying the magnetization of the ferromagnetic filaments (F) contained in the marked paper document (P) with time, and means of detection (Bd) of the variation in the magnetization of the ferromagnetic filaments (F).

10. Device according to claim 9, characterised in that the excitation means (A1, A2, A3; A4) comprise at least one permanent magnet animated by a movement relative to the marked paper document, the movement being made along an axis (AA′) parallel to the plane of the marked paper document.

11. Device according to claim 10, characterised in that the excitation means (A1, A2, A3) comprise a set of three permanent magnets in the form of three magnetised bars with an approximately rectangular or square section mounted in opposition, the axis defined by the north and south poles of each bar being perpendicular to the plane of the marked paper (P).

12. Device according to claim 10, characterised in that the excitation means (A4) comprise a permanent magnet in the form of a magnetised bar with an approximately rectangular or square section, the axis defined by the north and south poles of the document being approximately parallel to the plane of the marked paper document (P).

13. Device according to any one of claims 10 to 12, characterised in that the permanent magnets are placed on a magnetic yoke (CM).

14. Device according to claim 9, characterised in that the excitation means comprise at least one excitation coil (Be) through which an excitation current (ie) passes.

15. Device according to any one of claims 9 to 14, characterised in that the detection means comprise at least one detection coil (Bd) to transform the variations in the magnetisation of the ferromagnetic filaments (F), into tension variations.

16. Device according to claim 14 or 15, characterised in that the detection means comprise at least one compensation coil (Bc) mounted in series with the detection coil (Bd) to eliminate a signal component from the detected signal.

17. Document authentication device, characterised in that it comprises a detection device according to any one of claims 9 to 16.

18. Paper document reproduction control system, characterised in that it comprises a detection device according to any one of claims 9 to 16, and means of prohibiting reproduction of the paper document if the presence of ferromagnetic filaments is detected in the paper document.

19. Paper document reproduction apparatus, characterised in that it comprises a control system according to claim 18.

20. Apparatus according to claim 19, characterised in that it comprises a mobile arm (b) to move a light source (1) at the surface of a paper document to be reproduced and in that the detection device is fixed to the mobile arm.

21. Paper document reproduction process, characterised in that it comprises the following steps:
insertion of the paper document in a reproduction device according to claim 19,
detection of the presence or absence of ferromagnetic filaments (F) in the paper document,
prohibition to reproduce the paper document if ferromagnetic filaments are detected.

22. Process according to claim 21, characterised in that it comprises an additional step to authorize reproduction of the paper document if ferromagnetic filaments are detected to be present in the paper document.
